(19) United States
(12) Patent Application Publication
(10) Pub. No.: US 2007/0202849 A1
(43) Pub. Date: Aug. 30, 2007

(54) System And Method For Concatenating Short Audio Messages

(76) Inventor: Torben Liltorp Moeller, Lyngby (DK)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/597,458

(22) PCT Filed: Jan. 27, 2004
(86) PCT No.: PCT/IB04/00179

§ 371 Date: Feb. 26, 2007

(51) Int. Cl. G10L 21/00; H04Q 7/22

(52) U.S. Cl. 455/412.1

(57) ABSTRACT

This invention relates to a system (100) and method (150) for concatenating audio data packages and for transmitting the concatenated audio data packages between terminals (102; 104) connected in a network (108). This invention further relates to a terminal (10) continuously displaying progress of recordation (32) of each audio data package while displaying total number of audio data packages (30) of present audio message.

### FIELD OF INVENTION

This invention relates to a system and method for concatenating messages transferred through short audio messaging services (SAM) between terminals connected in a network, such as a mobile terminal in a wireless telecommunication network connected through a gateway to a computer terminal in a computer network.

### BACKGROUND OF INVENTION

Lately, the multimedia messaging services (MMS) have been introduced to mobile terminal networks. A MMS message may contain a picture, a series of pictures, a video, a series of videos, an audio recording, a series of audio recordings, or any combination thereof. The MMS messages have become important tools for handling business and common daily routines. A SAM message is a MMS transferred over a general packet radio service (GPRS), whereas a voicemail uses a circuit switched service as part of the global system for mobile communication (GSM). That is, a SAM message is delivered directly to a mobile terminal, where it may be played at any time, even when the mobile terminal is out of coverage of a mobile telecommunication network.

SAM services are advantageous for a network operator such as allowing the operator to send a SAM message during off peak hours, or during low network load, so as to balance the wireless telecommunication network load, and have many great advantages for users of wireless terminals such as enabling a user to avoid use of terminal keypad or keyboard to write text messages and enabling a user to speed up recording of a message.

In addition, the manufacturers of mobile terminals may achieve great advantages in designing mobile terminals, since by reducing the text handling capability of a mobile terminal the size of the mobile terminal may be significantly decreased and by removing language considerations in the text handling system of a mobile terminal a further element of the design process is eliminated.

Even though the SAM services have these many great advantages it is still capable of improvement. The length of a SAM message is fixed, thus preventing a flexibility of recording the SAM message. In order to achieve a better customer satisfaction and confidence in SAM services, the services must be flexible, that is, enable a user to record a variable length of a SAM message, and informative, that is inform a user of progress or recording and of length of a SAM message.

### SUMMARY OF THE INVENTION

An object of the present invention is to provide a method and system for concatenating SAM messages, so as to smoothly extend the length of a message constituted by a series of SAM messages.

A particular advantage of the present invention is the provision of a mobile terminal capable of concatenating SAM messages while concurrently informing the user recording a message of progress and length of message.

A particular feature of the present invention relates to the utilisation of a fixed length SAM message, which may be concatenated with further SAM messages in accordance with a user recording of an audio message, while informing the user of the progress of recording in each SAM message and the total number of used SAM messages for the audio message.

The above object, advantage and feature together with numerous other objects, advantages and features, which will become evident from below detailed description, are obtained according to a first aspect of the present invention by a terminal for concatenating recorded audio data packages each having a predefined length, such as SAM messages, into an audio message of variable length, each of said recorded audio data packages forwarded from said terminal to a receiving terminal through an interconnecting telecommunication network, and said terminal comprising:
(a) a user interface adapted to display on a display a first counter counting recorded length of audio data being recorded in an audio data package and a second counter counting number of recorded audio data packages,
(b) a recorder for recording each of said audio data packages,
(c) a concatenation unit for concatenating said recorded audio data packages into said audio message, and
(d) a transmitter for transmitting each of said recorded concatenated audio data packages through said telecommunication network to said receiving terminal.

The recorder according to the first aspect of the present invention may comprise a microphone for recording voice and/or a keypad for generating sounds. The recorder may thus record any combination of voice and sound effects. The sound effects may be polyphonic or monophonic and may be samples of tunes or music. Thus the audio message may be very versatile and provide the user of the transmitting terminal to record and forward a wide variety of messages to a user of a receiver. Furthermore, by enabling recording of audio data packages messaging becomes possible for illiterate people as well as enables “voice SMS”. In addition, by allowing the recording of audio data packages, instead of generation of text messages, the user confidence may be significantly increased, and written language capabilities and keypad requirements of the terminals be heavily reduced.

The user interface according to the first aspect of the present invention enables the user of the transmitting terminal to, advantageously, during a recording the audio message, continuously monitor the number of recorded audio data packages thereby being informed of the rendered costs of a transmission of the full audio message.

In addition, the user interface enables the user of the transmitting terminal to, advantageously, during recording of a particular audio data package, continuously monitor the progress of the recording of said particular audio data package. The predetermined length of the audio data package may be in the range between 10 seconds to 3 minutes, such as a predetermined length of 20 seconds.

The terminal as well as the receiving terminal according to first aspect of the present invention may comprise a mobile or cellular telephone, a personal digital assistant, a computer, or any combination thereof. In addition, the receiving terminal may comprise a computer terminal in a computer network, which computer terminal may be adapted to connect to the telecommunication network through a gateway interconnecting the telecommunication network and the computer network. The terminals may thus advantageously utilise many types of network for achieving a communication of an audio message. Hence the communication between the terminals is very flexible.

The telecommunication network according to the first aspect of the present invention may be a wireless telecommunication network using a general packet radio service transmission format or using a universal mobile telecommunications service transmission format. Obviously, any future format may in fact incorporate the advantages of the present invention.

The above object, advantage and feature together with numerous other objects, advantages and features, which will become evident from below detailed description, are obtained according to a second aspect of the present invention by a system for communicating concatenated recorded audio data packages each having a predetermined length, such as SAM messages, into an audio message of variable length, and said system comprising:
(a) a transmitting terminal adapted to generate said concatenated recorded audio data packages and to transmit each of said recorded audio data packages, and comprising:
   (i) a user interface adapted to display on a display a first counter counting recorded length of audio data being recorded in an audio data package and a second counter counting number of recorded audio data packages,
   (ii) a recorder for recording each of said audio data packages,
   (iii) a concatenation unit for concatenating said recorded audio data packages into said audio message, and
   (iv) a transmitter for transmitting each of said recorded concatenated audio data packages through said telecommunication network to said receiving terminal.
(b) a receiving terminal for receiving said concatenated recorded audio data packages from said transmitting terminal and comprising:
   (i) a receiver for receiving said concatenated recorded audio data packages and for configuring said concatenated recorded audio data packages into said audio message, and
   (ii) a loudspeaker for playing said audio message, and
(c) a telecommunication network interconnecting said transmitting and receiving terminal.

The transmitting and receiving terminals according to the second aspect of the present invention may comprise any features of the transmitting terminal according to the first aspect.

The system according to the second aspect of the present invention may further comprise a computer terminal in a computer network connecting to the telecommunication network through a gateway interconnecting the telecommunication network with the computer network. By introducing a gateway and a computer terminal additional advantages arise, since this provides the possibility of connecting up to for example service providers of various types.

The computer network may comprise a wired or wireless local area network, metropolitan area network, wide area network, inter-network (e.g. the Internet), television network, power network, or any combination thereof. Further, the telecommunication network may comprise a wireless telecommunication network using a general packet radio service transmission format or using a universal mobile telecommunication service transmission format. As indicated above with reference to the second aspect of the present invention the terminals may utilise many types of network to achieve a communication of an audio message. Hence the communication between the terminals is very flexible.

The above object, advantage and feature together with numerous other objects, advantages and features, which will become evident from below detailed description, are obtained according to a third aspect of the present invention by a method for concatenating recorded audio data packages each having a predefined length, such as SAM messages, into an audio message of variable length, each of said recorded audio data packages forwarded from a transmitting terminal to a receiving terminal through an interconnecting telecommunication network, and said method comprising;
(a) displaying, when a first counter is smaller than said predetermined length, said first counter and a second counter by means of a display on said transmitting terminal, said first counter counting recorded length of audio data being recorded in an audio data package and said second counter counting number of recorded audio data packages,
(b) recording, when said first counter is smaller than said predefined length, an audio data package by means of a recorder in said transmitting terminal,
(c) concatenating said recorded audio data packages into said audio message by means of a concatenation unit in said transmitting terminal, and
(d) transmitting each of said recorded concatenated audio data packages through said telecommunication network to said receiving terminal by means of a transmitter in said transmitting terminal.

The above object, advantage and feature together with numerous other objects, advantages and features, which will become evident from below detailed description, are obtained according to a fourth aspect of the present invention by a user interface for implementing in a terminal according to the first aspect of the present invention.

The user interface according to the fourth aspect of the present invention provides a higher satisfaction and confidence in using audio data packages such as SAM services.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1, shows a mobile terminal according to a first embodiment of the present invention,

FIG. 2, shows a flow chart of the method for concatenating audio data packages such as implemented in a terminal, such as the mobile terminal according to the first embodiment, and

FIG. 3, shows a system for concatenating audio data packages into a audio message according to a second and third embodiment of the present invention.

### DETAILED DESCRIPTION OF PREFERRED EMBODIMENTS

In the following description of the various embodiments, reference is made to the accompanying drawing showing by way of illustration the various embodiments in which the invention may be practiced. It is to be understood that other embodiments may be utilized, and structural and functional modifications may be made without departing from the scope of the present invention.

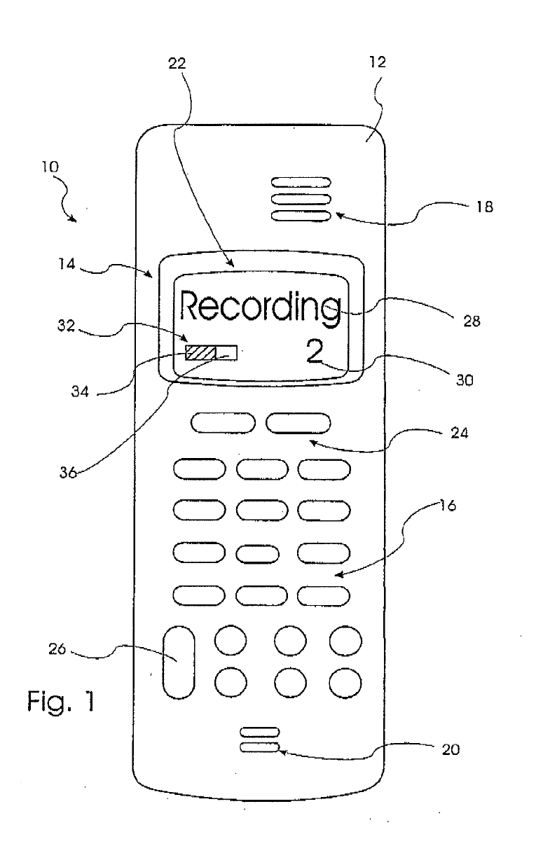

FIG. 1, shows a mobile terminal designated in entirety by reference numeral 10. The term mobile terminal should in this context be construed as a mobile or cellular access means to a communication network, that is, the term terminal should in this context be construed as a telephone, a computer, a personal digital assistant, or any combination thereof. The term communication network should in this context be construed as a wired or wireless telecommunication network, a wired or wireless computer network such as a local area network, a wide area network, a metropolitan area network or an internetwork (e.g. the Internet), a wired power network, or any combination thereof.

The mobile terminal 10 comprises a cover 12, a display 14, a keypad 16, a loud speaker 18 and a microphone 20. The display 14 in FIG. 1 shows a user interface 22 for enabling a user of the mobile terminal 10 to record an audio message to be forwarded over a communication network, such as a mobile telecommunication network. The term audio message should in this context be construed as a message comprising one or more data packages of audio information, that is, an audio message may comprise a concatenation of packages. Hence a package should in this context be construed as an audio data packages such as a SAM message.

The user accesses a “recording” mode through a selection in a menu using control keys 24 or a hot key 26 in the keypad 15. The user controls the interface 22 for the “recording” mode through the control keys 24 in the keypad 16. The entering of the “recording” mode is visualized for the user by an icon or text 28. In the “recording” mode the user may generate an audio message by speaking into the microphone 20 or by generating sound effects through the keypad 16. While the user operates the mobile terminal 10 in the “recording” mode, the interface 22 continuously displays a number 30 informing the user of the number of packages, namely SAM messages, the user has recorded during the present “recording” mode session. Further, in the “recording” mode the interface 22 continuously displays a sign 32 informing the user how much of the present package has been used.

The sign 32, shown in FIG. 1, comprises a bar 34 filling part of a window 36. The bar 34 illustrates the recorded time and the window 36 shows the total time allowed in a package. Obviously, the sign 32 may be implemented in a wide variety of ways known to a person skilled in the art. For example, the sign 32 may be as a pancake circle, a percentage, or a simple counter such as a numerical value.

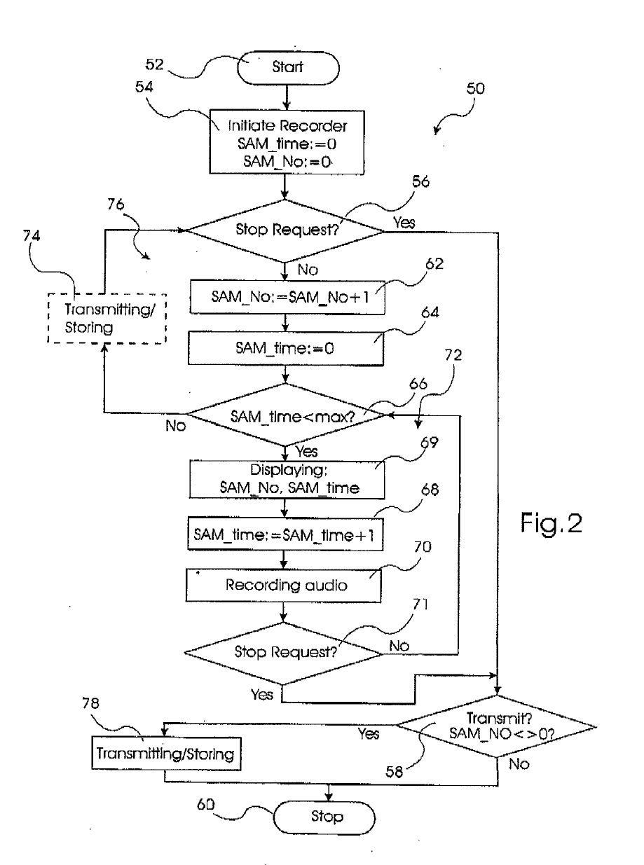

FIG. 2, shows a method for concatenating audio data package, such as SAM messages, in a terminal and for displaying information regarding number of audio data packages recorded and length of present audio data package. The method is designated in entirety by reference numeral 50.

The method 50 comprises a start 52, during which the application call to the method 50 is handled by the processor of the mobile terminal. The application call may be established by a hardware interrupt for example by pressing a hot key on a keypad of a terminal, or may be established by a software application call. The start 52 is followed by initiation 54, during which the parameters used in the method 50 are reset.

The initiation 54 comprises setting counters SAM_time, and SAM_No to zero. The SAM_time counter keeps track of the time used during one audio data package. The audio data package has a finite maximum length, such as in the range 10 seconds to 3 minutes, e.g. 20 seconds. The SAM_No counter keeps track of the number of audio data packages used.

Following the initiation 54 the method 50 continues to inquire: stop request? 56, that is, to detect whether a stop instruction is received. The stop request may be initiated either through a microphone (vocal control) of the terminal or through a keypad or keyboard (hardware control) of the terminal.

In case a stop request is detected by stop request? 56 the method 50 continues by inquiring: transmit? 58, during which the user of the terminal generally is requested to decide whether to store or transmit the audio data packages. Needless to say that if the method 50 in stop request? 56 has detected a stop request and it the counter SAM_No equals zero, the method 50 continues to stop 60.

In case no stop request is detected in the stop request? 56 the method 50 continues to increase the counter SAM_No 62 and reset the SAM_Time 64 before continuing to inquire whether SAM_time is smaller than maximum length 66.

When the method 50 continues from resetting the SAM_time 64 to inquiring whether SAM_time is smaller than maximum length 66 the result is, since SAM_time has just been reset, that the method 50, firstly, continues to display the counters 69 SAM_No and SAM_time and, secondly, continues to increase the counter SAM_time 68 and record audio 70. This is repeated in loop 72 until the counter SAM_time has reached its maximum length or until a stop request is detected during stop request? 71. Hence a transmitting terminal according to the first embodiment of the present invention continuously display actual length of an audio message by displaying the length of the present SAM (SAM_time) and the total number of SAMs recorded (SAM_No),

By displaying the number of audio data packages recorded the user is continuously advised of the potential price of the total audio message, since the user of a terminal is generally informed of the price for transmitting audio data packages, such as a SAM message. Further, by displaying the length or time of the presently recorded audio data package, the user is continuously advised of the utilisation of the audio data package and may thus optimize the usage of each audio data message.

When the counter SAM_time has reached its maximum length, the method 50 when asking whether SAM_time is smaller than the maximum length 66, continues in a first embodiment of the present invention to the user is required to decide whether to transmit or store 74 an audio data package. In a second embodiment of the present invention the transmit or store 74 is bypassed so as to delay transmission or storage to a later stage in the method 50. Following transmit or store 74 in the first embodiment of the present invention and following asking whether SAM_time is smaller than the maximum length 66 in the second embodiment of the present invention, the method so returns to stop request? 56.

In case no stop request is detected during stop request? 56 the method 50 continues in loop 76, that is, increasing the counter SAM_No 62 and resetting the counter SAM_time 64. In other words, the method 50 continues to record audio in a second audio data package by entering loop 72. The loop 72 and the loop 74 are repeated as long at no stop request is detected during stop request? 56.

In case a stop request is detected during stop request? 56 the method 50 continues to transmit? 58. When confirmation is received the method 50 continues to transmit or store 78. In the first embodiment of the present invention the recorded audio data packages, such as SAM messages, are transmitted or stored as soon as they are recorded. In the second embodiment of the present invention the recorded audio data packages are transmitted or stored during transmit or store 78.

During transmit or store 74 and transmit or store 58 the audio data package is encapsulated by concatenation information allowing the receiving terminal to re-assemble the audio message from the concatenated audio data packages. Any concatenation methods known to a person skilled in the art may be implemented.

When transmit or store 78 is completed the method 50 stops 60.

A user of a terminal may at any time access stored audio data packages so as to transmit, replay, edit or delete these at will. The audio data packages are locally stored on the terminal so access even outside telecommunication net range is possible.

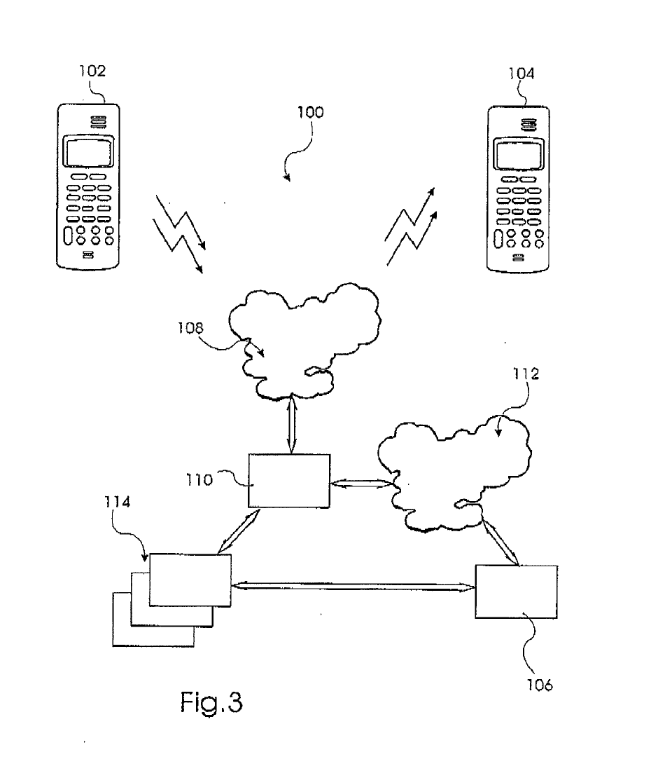

FIG. 3, shows a system for concatenating audio data package, such as SAM messages, and which system is designated in entirety by reference numeral 100.

The system 100 comprises a transmitting mobile terminal 102, a receiving mobile terminal 104, and a receiving stationary terminal 106. The transmitting mobile terminal 102 may record a number of audio data packages to be concatenated to form an audio message to be forwarded through a wireless telecommunication network 108 to the receiving mobile terminal 104 or to a gateway 110 connecting to the wireless telecommunication network 108. The gateway 110 interconnects the transmitting mobile terminal with the receiving stationary terminal 105 through a computer network 112. The gateway 110 further connects to service providers 114 providing services to either the receiving and transmitting mobile terminals 102, 104 and/or to the receiving stationary terminal 106.

The telecommunication network 108 uses a general packet radio service transmission (GPRS) format or a universal mobile telecommunication service (UMTS).

1. A terminal for concatenating recorded audio data packages each having a predefined length, such as SAM messages, into an audio message of variable length, each of said recorded audio data packages forwarded from said terminal to a receiving terminal through an interconnecting telecommunication network, and said terminal comprising:
(a) a user interface adapted to display on a display a first counter counting recorded length of audio data being recorded in an audio data package and a second counter counting number of recorded audio data packages,
(b) a recorder for recording each of said audio data packages,
(c) a concatenation unit for concatenating said recorded audio data packages into said audio message, and
(d) a transmitter for transmitting each of said recorded concatenated audio data packages through said telecommunication network to said receiving terminal.

2. A terminal according to claim 1, wherein said recorder comprises a microphone for recording voice and/or a keypad for generating sounds.

3. A terminal according to claim 1, wherein said predetermined length of said audio data package is in the range between 10 seconds to 3 minutes.

4. A terminal according to claim 1, wherein said terminal comprises a mobile or cellular telephone, a personal digital assistant, a computer, or any combination thereof.

5. A terminal according to claim 1, wherein said receiving terminal comprises a mobile or cellular telephone, a personal digital assistant, a computer, or any combination thereof.

6. A terminal according to claim 1, wherein said receiving terminal comprises a computer terminal in a computer network, said computer terminal being adapted to connect to said telecommunication network through a gateway interconnecting said telecommunication network and said computer network.

7. A terminal according to claim 1, wherein said telecommunication network is a wireless telecommunication network.

8. A terminal according to claim 7, wherein said wireless telecommunication network uses a general packet radio service transmission format.

9. A terminal according to claim 7, wherein said wireless telecommunication network uses universal mobile telecommunication service transmission format.

10. A system for communicating concatenated recorded audio data packages each having a predefined length, such as SAM messages, into an audio message of variable length, and said system comprising:
(a) a transmitting terminal adapted to generate said concatenated recorded audio data packages and to transmit each of said recorded audio data packages, and comprising:
(i) a user interface adapted to display on a display a first counter counting recorded length of audio data being recorded in an audio data package and a second counter counting number of recorded audio data packages,
(ii) a recorder for recording each of said audio data packages,
(iii) a concatenation unit for concatenating said recorded audio data packages into said audio message, and
(iv) a transmitter for transmitting each of said recorded concatenated audio data packages through said telecommunication network to said receiving terminal.
(b) a receiving terminal for receiving said concatenated recorded audio data packages from said transmitting terminal and comprising:
(i) a receiver for receiving said concatenated recorded audio data packages and for configuring said concatenated recorded audio data packages into said audio message, and
(ii) a loudspeaker for playing said audio message, and
(c) a telecommunication network interconnecting said transmitting and receiving terminal.

11. A system according to claim 10, wherein said recorder of said transmitting terminal comprises a microphone for recording voice and/or a keypad for generating sounds.

12. A system according to claim 10, wherein said receiving terminal comprises a mobile or cellular telephone, a personal digital assistant, a computer, or any combination thereof.

13. A system according to claim 10 further comprises a computer terminal in a computer network connecting to said telecommunication network through a gateway interconnecting said telecommunication network with said computer network.

14. A system according to claim 13, wherein said computer network comprises a wired or wireless local area network, metropolitan area network, wide area network, inter-network, television network, power network, or any combination thereof.

15. A system according to claim 10, wherein said telecommunication network is a wireless telecommunication network.

16. A system according to claim 15, wherein said wireless telecommunication network uses a general packet radio service transmission format.

17. A system according to claim 15, wherein said wireless telecommunication network uses universal mobile telecommunication service transmission format.

18. A method for concatenating recorded audio data packages each having a predefined length, such as SAM messages, into an audio message of variable length, each of said recorded audio data packages forwarded from a transmitting terminal to a receiving terminal through an interconnecting telecommunication network, and said method comprising:
(a) displaying, when a first counter is smaller than said predefined length, said first counter and a second counter by means of a display on said transmitting terminal, said first counter counting recorded length of audio data being recorded in an audio data package and said second counter counting number of recorded audio data packages,
(b) recording, when said first counter is smaller than said predefined length, an audio data package by means of a recorder in said transmitting terminal,
(c) concatenating said recorded audio data packages into said audio message by means of a concatenation unit in said transmitting terminal, and
(d) transmitting each of said recorded concatenated audio data packages through said telecommunication network to said receiving terminal by means of a transmitter in said transmitting terminal.

19. A user interface for implementation in a terminal according to claim 1.
